(19) United States
(12) Patent Application Publication
(10) Pub. No.: US 2024/0161013 A1
(43) Pub. Date: May 16, 2024

(54) AUTOMATIC INITIALIZATION TOOL FOR REPARAMETERIZATION FROM USER-SPECIFIED WEIGHTS

(71) Applicant: MEDIATEK INC., Hsin-Chu (TW)

(72) Inventors: Cheng-Yu Yang, Hsinchu City (TW); Hao Chen, Hsinchu City (TW); Po-Hsiang Yu, Hsinchu City (TW); Peng-Wen Chen, Hsinchu City (TW)

(73) Assignee: MEDIATEK INC., Hsin-Chu (TW)

(21) Appl. No.: 18/501,039

(22) Filed: Nov. 3, 2023

Related U.S. Application Data
(60) Provisional application No. 63/383,513, filed on Nov. 14, 2022.

(51) Int. Cl. G06N 20/00

(52) U.S. Cl. CPC G06N 20/00

(57) ABSTRACT

A reparameterization method for initializing a machine learning model includes initializing a prefix layer of a first low dimensional layer in the machine learning model and a postfix layer of the first low dimensional layer, inverting the prefix layer to generate an inverse prefix layer of the first low dimensional layer, inverting the postfix layer to generate an inverse postfix layer of the first low dimensional layer, combining the inverse prefix layer, the first low dimensional layer and the inverse postfix layer to form a high dimensional layer, generating parallel operation layers from the high dimensional layer, and assigning initial weights to the parallel operation layers.

### CROSS REFERENCE TO RELATED APPLICATIONS

This application claims the benefit of U.S. Provisional Application No. 63/383,513, filed on Nov. 14, 2022. The content of the application is incorporated herein by reference.

### BACKGROUND

In the field of Computer Vision (CV), no matter how challenging vision transformer is, convolution neural network (CNN) in machine learning is always one of the most popular architectures. In order to improve the effect of convolution neural network, one of the commonly used designs in recent years is to use a residual path or multi-branch path to make the convolution neural network model behave like an ensemble model.

The residual path and multi-branch path improve the performance of convolution neural network, but such architecture may have poor execution efficiency on most hardware. A new method is proposed to maintain the multi-branch path during training, but to be reparameterized into a plain model during inference. This allows the model to improve its performance while still maintaining the computational efficiency of the plain CNN model. So far, this method using reparameterization can be said to have passed the test of time and has been widely used or further improved in many computational optimization models.

However, reparameterization blocks suffer from training instability such as gradient exploding and gradient vanishing due to the gain addition and multiplication of kernels. Therefore, the user needs to specify the gain of each kernel to obtain training stability, which is very time-consuming.

### SUMMARY

A reparameterization method for initializing a machine learning model includes initializing a prefix layer of a first low dimensional layer in the machine learning model and a postfix layer of the first low dimensional layer, inverting the prefix layer to generate an inverse prefix layer of the first low dimensional layer, inverting the postfix layer to generate an inverse postfix layer of the first low dimensional layer, combining the inverse prefix layer, the first low dimensional layer and the inverse postfix layer to form a high dimensional layer, generating parallel operation layers from the high dimensional layer, and assigning initial weights to the parallel operation layers.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is schematic diagram of a reparameterization method for initializing a machine learning model according to an embodiment of the present invention.

FIG. 2A is a concept map of the transformation from the first low dimensional layer to the high dimensional layer according to an embodiment of the present invention.

FIG. 2B is a concept map of the transformation from the high dimensional layer to the first low dimensional layer according to an embodiment of the present invention.

FIG. 3 is a concept map of the transformation between the high dimensional layer and the parallel operation layers according to an embodiment of the present invention.

FIG. 4 is the flowchart of a reparameterization method for initializing a machine learning model according to an embodiment of the present invention.

FIG. 5 is the flowchart of a reparameterization method for initializing a machine learning model according to another embodiment of the present invention.

### DETAILED DESCRIPTION

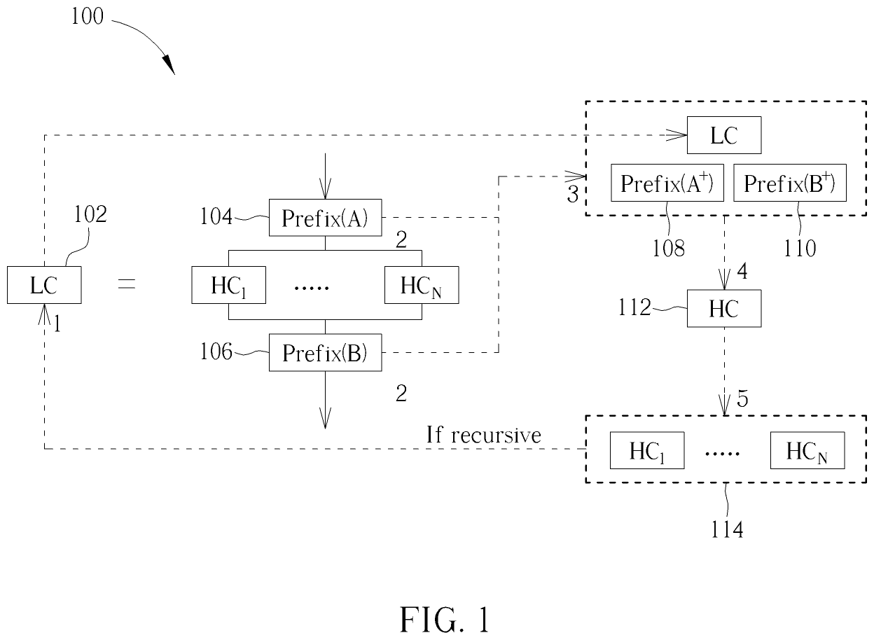

FIG. 1 is schematic diagram of a reparameterization method 100 for initializing a machine learning model according to an embodiment of the present invention. A first low dimensional layer 102 can be represented as a prefix layer 104, parallel operation layers 114, and a postfix layer 106 if the parameters of the prefix layer 104, the parallel operation layers 114, and the postfix layer 106 are properly assigned to make their computations equal and to stabilize the training of the machine learning model. At first, a first low dimensional layer 102 is initialized. Secondly, a prefix layer 104 and an inverse prefix layer 108 are added at the input of the first low dimensional layer 102. Third, a postfix layer 106 and an inverse postfix layer 110 are added at the output of the first low dimensional layer 102. The inverse prefix layer 108, the first low dimensional layer 102, and the inverse postfix layer 110 can be combined to generate a high dimensional layer 112. Moreover, the high dimensional layer 112 is represented as parallel operation layers 114. If one of the parallel operation layers 114 can be further reparameterized recursively, then the parallel operation layer becomes a second low dimensional layer to repeat the procedure again. Therefore, a low dimensional layer can be replaced with a prefix layer, a high dimensional layer which can be further segmented recursively, and a postfix layer.

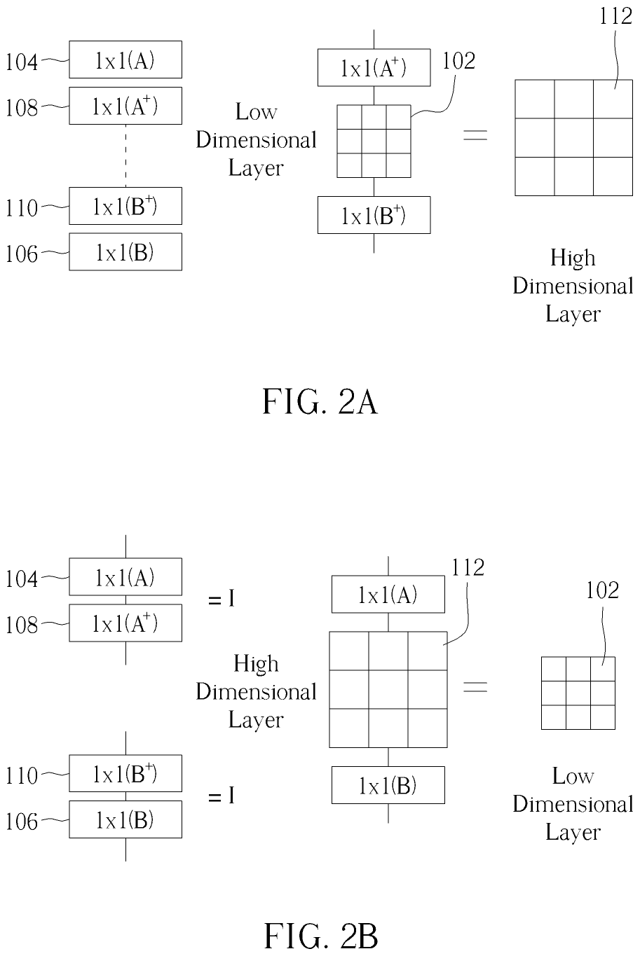

FIG. 2A is a concept map of the transformation from the first low dimensional layer 102 to the high dimensional layer 112 according to an embodiment of the present invention. The prefix layer 104 and the inverse prefix layer 108 are added at the input of the first low dimensional layer 102. The computation result is equal after adding the prefix layer 104 and the inverse prefix layer 108 because the combination of the prefix layer 104 and the inverse prefix layer 108 is an identity layer, which keeps the computation result the same. The inverse postfix layer 110 and the postfix layer 106 are added at the output of the first low dimensional layer 102. The computation result is equal after adding the inverse postfix layer 110 and the postfix layer 106 because the combination of the inverse postfix layer 110 and the postfix layer 106 is an identity layer, which keeps the computation result the same. Therefore, the inverse prefix layer 108, the first low dimensional layer 102, and the inverse postfix layer 110 can be combined to generate the high dimensional layer 112, which keeps computation equal and the training of machine learning model stable.

FIG. 2B is a concept map of the transformation from the high dimensional layer 112 to the first low dimensional layer 102 according to an embodiment of the present invention. The prefix layer 104 and the inverse prefix layer 108 are added at the input of the first low dimensional layer 102. The computation result is equal after adding the prefix layer 104 and the inverse prefix layer 108 because the combination of the prefix layer 104 and the inverse prefix layer 108 is an identity layer, which keeps the computation result the same. An inverse postfix layer 110 and the postfix layer 106 are added at the output of the first low dimensional layer 102. The computation result is equal after adding the inverse postfix layer 110 and the postfix layer 106 because the combination of the inverse postfix layer 110 and the postfix layer 106 is an identity layer, which keeps the computation result the same. Therefore, the prefix layer 104, the high dimensional layer 112, and the postfix layer 106 can be combined to generate the first low dimensional layer 102, which keeps computation equal and the gain of machine learning model stable.

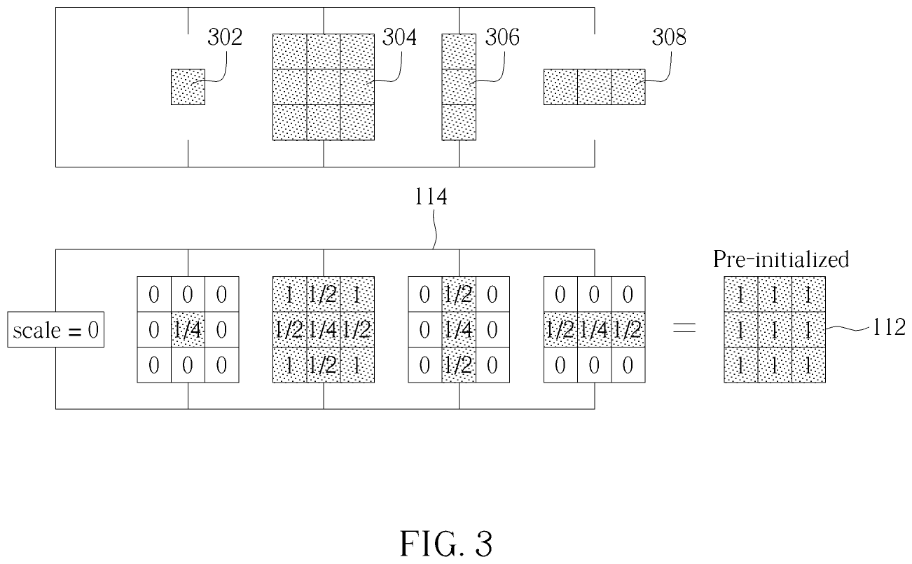

FIG. 3 is a concept map of the transformation between the high dimensional layer 112 and the parallel operation layers 114 according to an embodiment of the present invention. In FIG. 3, the parallel operation layers 114 include a 1×1 operation layer 302, a 3×3 operation layer 304, a 3×1 operation layer 306, and a 1×3 operation layer 308. The pre-initialized high dimensional layer 112 is filled with is in the 3×3 matrix, and the elements are divided into four matrices of the parallel operation layers based on the uniform distribution. That is, the 1×1 operation layer 302 is filled with ¼. The 3×3 operation layer 304 is filled with 1, ½, 1, ½, ¼, ½, 1, ½, 1. The 3×1 operation layer 306 is filled with ½, ¼, ½. The 1×3 operation layer 308 is filled with ½, ¼, ½. However, to combine the parallel operation layers together, the size of matrices should be the (maximum M)×(maximum N), which is 3×3 in FIG. 3. That is, the lxi operation layer 302 spread into a 3×3 matrix is filled with 0, 0, 0, 0, ¼, 0, 0, 0, 0. The 3×3 operation layer 304 is filled with 1, ½, 1, ½, ¼, ½, 1, ½, 1. The 3×1 operation layer 306 spread into a 3×3 matrix is filled with 0, ½, 0, 0, ¼, 0, 0, ½, 0. The 1×3 operation layer 308 spread into a 3×3 matrix is filled with 0, 0, 0, ½, ¼, ½, 0, 0, 0. In this way, the high dimensional layer 112 can be represented as parallel operation layers by assigning the initial weights to keep computation equal and the training of machine learning model stable. In another embodiment, the pre-initialized high dimensional layer 112 is filled with is in the 3×3 matrix, and the elements are divided into four matrices of the parallel operation layers based on an arbitrary probability distribution.

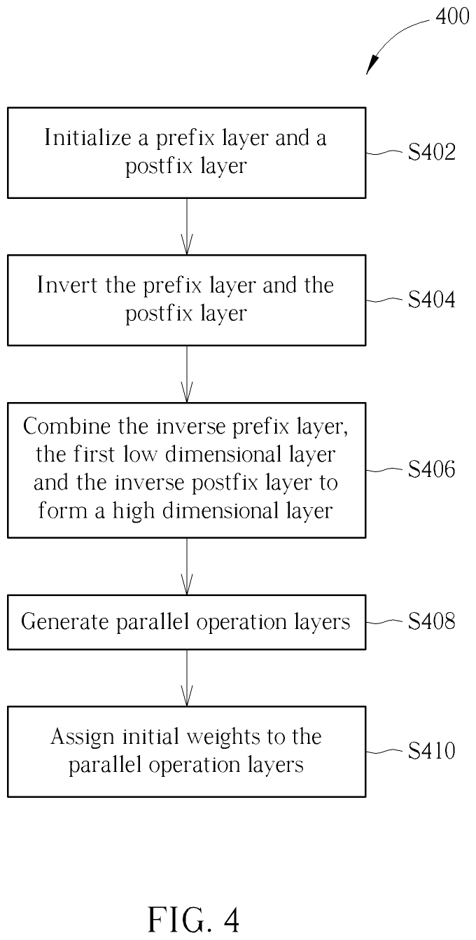

FIG. 4 is the flowchart of a reparameterization method 400 for initializing a machine learning model according to an embodiment of the present invention.

Step S402: Initialize the prefix layer 104 and the postfix layer 106;

Step S404: Invert the prefix layer 104 and the postfix layer 106;

Step S406: Combine the inverse prefix layer 108, the first low dimensional layer 102 and the inverse postfix layer 110 to form the high dimensional layer 112;

Step S408: Generate the parallel operation layers 114;

Step S410: Assign initial weights to the parallel operation layers 114.

Steps S402, S404 and S406 are described in FIG. 2A and FIG. 2B, and Steps S408 and S410 are described in FIG. 3.

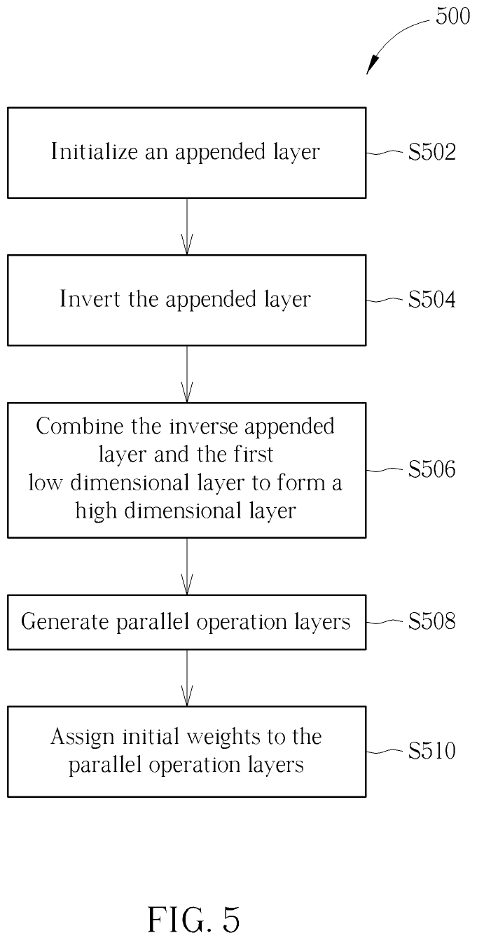

FIG. 5 is the flowchart of a reparameterization method 500 for initializing a machine learning model according to another embodiment of the present invention.

Step S502: Initialize an appended layer;

Step S504: Invert the appended layer;

Step S506: Combine the inverse appended layer and the first low dimensional layer 102 to form a high dimensional layer 112;

Step S508: Generate parallel operation layers 114;

Step S510: Assign initial weights to the parallel operation layers 114.

In step S502, the appended layer such as a prefix layer 104 or a postfix layer 106 is initialized. In step S504, the inverse appended layer is generated, and in step S506, the inverse appended layer and the first low dimensional layer 102 are combined to form the high dimensional layer 112. Then, in step S508, the parallel operation layers 114 are generated to replace the high dimensional layer 112. At last, in step S510, the initial weights of the parallel operation layers 114 are assigned.

The embodiments can add only one appended layer or can add both prefix layer and postfix layer to the first low dimensional layer. After the reparameterization, the computation result is equal and the training of machine learning model is further stabilized.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A reparameterization method for initializing a machine learning model, comprising:
initializing a prefix layer of a first low dimensional layer in the machine learning model and a postfix layer of the first low dimensional layer;
inverting the prefix layer to generate an inverse prefix layer of the first low dimensional layer;
inverting the postfix layer to generate an inverse postfix layer of the first low dimensional layer;
combining the inverse prefix layer, the first low dimensional layer and the inverse postfix layer to form a high dimensional layer;
generating parallel operation layers from the high dimensional layer; and
assigning initial weights to the parallel operation layers.

2. The method of claim 1, wherein the machine learning model contains a sequential structure.

3. The method of claim 1, wherein the high dimensional layer is a sum of the parallel operation layers.

4. The method of claim 1, wherein each of the parallel operation layers is a skip-connection layer, or an M×N convolution layer.

5. The method of claim 1, wherein at least one of the parallel operation layers contains a second low dimensional layer.

6. The method of claim 1, wherein:
at least one of the parallel operation layers is learnable;
an intermediate channel between the prefix layer and the parallel operation layer is larger than an input channel to the prefix layer; and
an intermediate channel between the postfix layer and the parallel operation layer is larger than an output channel from the postfix layer.

7. The method of claim 1, wherein the parallel operation layers are of a same size.

8. The method of claim 1, wherein assigning the initial weights to the parallel operation layers is performed according to an arbitrary probability distribution.

9. The method of claim 1, wherein the low-dimensional layer is a convolution layer, an elementwise operation layer, or a scaling layer, and the high-dimensional layer is a convolution layer, an elementwise operation layer, or a scaling layer.

10. A reparameterization method for initializing a machine learning model, comprising:
initializing an appended layer of a first low dimensional layer in the machine learning model;
inverting the appended layer to generate an inverse appended layer of the first low dimensional layer;
combining the inverse appended layer, and the first low dimensional layer to form a high dimensional layer;
generating parallel operation layers from the high dimensional layer; and
assigning initial weights to the parallel operation layers.

11. The method of claim 10, wherein the machine learning model contains a sequential structure.

12. The method of claim 10, wherein the high dimensional layer is a sum of the parallel operation layers.

13. The method of claim 10, wherein each of the parallel operation layers is a skip-connection layer, or an M×N convolution layer.

14. The method of claim 10, wherein at least one of the parallel operation layers contains a second low dimensional layer.

15. The method of claim 10, wherein the appended layer is a prefix layer, and an intermediate channel between the prefix layer and the parallel operation layer is larger than an input channel to the prefix layer.

16. The method of claim 10, wherein the appended layer is a postfix layer, and an intermediate channel between the postfix layer and the parallel operation layer is larger than an output channel from the postfix layer.

17. The method of claim 10, wherein the parallel operation layers are of a same size.

18. The method of claim 10, wherein assigning the initial weights to the parallel operation layers is performed according to an arbitrary probability distribution.

19. The method of claim 10, wherein the low-dimensional layer is a convolution layer, an elementwise operation layer, or a scaling layer, and the high-dimensional layer is a convolution layer, an elementwise operation layer, or a scaling layer.
